(19) United States
(12) Patent Application Publication
(10) Pub. No.: US 2008/0227494 A1
(43) Pub. Date: Sep. 18, 2008

(54) Method For Transmitting A Sound-Film Message From A Mobile Terminal To Any E-Mail Address

(75) Inventors: Valeri Mikhailovich Abramson, Moscow (RU); Dmitri Nikolaevich Bragin, Moscow (RU)

Correspondence Address: OBLON, SPIVAK, MCCLELLAND MAIER & NEUSTADT, P.C., 1940 DUKE STREET, ALEXANDRIA, VA, 22314, US

(73) Assignee: MAYFAIR COURT CONSULTANTS LIMITED, London (GB)

(21) Appl. No.: 11/997,647

(22) PCT Filed: May 24, 2006
(86) PCT No.: PCT/EA2006/000005

§ 371 Date: Apr. 18, 2008

(30) Foreign Application Priority Data
Aug. 3, 2005 (EA) 200501084

(51) Int. Cl. H04B 1/44

(52) U.S. Cl. 455/560

(57) ABSTRACT

The invention relates to means for mobile communications and transmission of data via electronic mail.

The object of the invention is to enable a mobile user to transmit an audio message from a mobile terminal to any electronic mail address.

In a method for transmitting an audio message from a mobile terminal, including a terminal without Internet access, to any electronic mail address, a mobile user calls from a mobile terminal to a service system of a provider of the service and establishes connection with the service system; the service system identifies the user, receives and stores the user's audio message as a file, and transmits the file to one or more electronic mail addresses indicated by the user.

### FIELD OF THE INVENTION

The present invention relates generally to mobile communication means and transmission of data via electronic mail, and more specifically to means enabling a mobile user to transmit an audio message from a mobile terminal, including a mobile terminal without Internet access, to an electronic mailbox.

### BACKGROUND OF THE INVENTION

In a known method for transmitting an audio message file by a mobile user, a user having a mobile terminal connected to the Internet transmits a file stored in the mobile terminal memory over the Internet to any electronic mailbox. From the user's viewpoint, the method does not differ from transmission of files through the common e-mail from a personal computer connected to the Internet, except that the Internet is accessed from a mobile terminal over cellular channels.

Voice mail systems are also known in the art. Such services are generally offered to users by cellular operators, where a calling party may leave a voice message for a called party under certain conditions, e.g. when the called party's telephone is busy, switched off, out of the area of network coverage, etc. The voice message is stored at the operator's side, and the user is able to perform different actions thereon (listen, delete, forward to another user, etc.).

A method according to the present invention differs in that a user can create, at a provider's server, a database of e-mail addresses with the aid of SMS messages or through the provider's web-site and assign a definite unique number to each address. Later on, having called to the provider's service system the user can record an audio message and transmit only the number (or several numbers) of e-mail addresses to the service system via the telephone keypad, because the user, being in the system voice menu, has no opportunity to transmit the string of symbols forming the e-mail address. Based on the number, the service system selects from the address database the string of symbols forming the e-mail address. The provider's server then forwards the audio file to the indicated e-mail address in the usual manner, via the Internet.

The method provides an easy way for a user to transmit, in addition to an audio message, the e-mail address of the message recipient to the service system quickly and accurately. It is also convenient that the addresses are stored at the provider's server, and a user is able to manage them remotely (delete, add, edit) at any time. A user is also able to store audio messages as files at the provider's server and manage them. Files are advantageously sent to the address indicated by a user from the provider's server via e-mail, rather than from the user's mobile terminal.

Therefore, to be able to implement a method for transmitting an audio message to an electronic mail address according to the invention a user needs a mobile telephone with minimum capabilities, namely, the capability to transmit voice traffic and SMS messages. The method does not require an Internet-enabled telephone.

No closest prior art has been found in respect of the present method.

### OBJECT OF THE INVENTION

The object of the present invention is to enable a mobile user to transmit an audio message from a mobile terminal to any electronic mail address.

The object is accomplished in a method for transmitting an audio message from a mobile terminal, including a mobile terminal without Internet access, to any electronic mail address, wherein a user calls from a mobile terminal to a service system of a provider of the service and establishes connection with the service system; the service system identifies the user; the user transmits an audio message; the service system receives the user's audio message, stores the audio message as a file and transmits the file or a previously stored file to one or more electronic mail addresses indicated by the user.

### DESCRIPTION OF THE INVENTION

Definition of the terms used in the claim.

“Provider of the service”

At present, a variety of value-added services (VAS-services) are offered to mobile users in addition to standard services of voice traffic transmission.

Basic VAS-services include: SMS (Short Message Service) requests for requesting various reference information; MMS (Multimedia Messaging Service) for receiving/transmitting graphical and musical files, pictures, etc.; WAP (Wireless Application Protocol) for providing global wireless access to the Internet resources from a user's mobile terminal; GPRS/EDGE (General Packet Radio Service/Enhanced Data Rates for GSM Evolution) for providing high-speed Internet access via a mobile telephone connected e.g. to a portable computer, and other services.

The process of providing VAS-services to a user generally involves mobile operators, aggregators, service providers, content providers, applications providers, etc.

The term “party” will refer to any subject from following list: user, mobile operator, aggregator, service provider, content provider, applications provider, while the term “parties” will refer to any combinations thereof.

Function of each party will be described below, although the terminology has not been completely established, and the functional division of parties presented below is quite a matter of convention.

“Content” refers to any information which can be received/transmitted over various communication channels, e.g. files of various formats (text, graphics, audio), URL references, SMS messages, HTML/WAP pages, video, voice messages, etc.

“Mobile operator” is a person or entity (company) eligible to provide mobile communication services.

“User” is a person or entity for whom a mobile operator provides, generally on a contractual basis, mobile communication services, and having a telephone number of the mobile operator network. Mobile communication users are the basic end consumers of content and services.

“Aggregator” is a company acting as an agent between a mobile operator and service/content providers, which establishes various arrangements with providers and an operator to optimize the process of content and/or service delivery to users.

“Service provider” is a company that provides content-based services to mobile users directly or via a mobile operator. Service provider can also provide services to a mobile operator, aggregator and content provider. Main types of services offered by a service provider include: transit of content between different platforms; telecommunication access to resources of clients (Intranet/Internet services), including access over mobile communication channels; provision of content to a mobile user by connecting him with a content provider's platform through re-addressing from a short operator's number or over a dedicated channel; organization of SMS/MMS gateways and Internet gateways; call-center services for processing traffic from users to mobile operators, etc. Service provider may be also a content copyright holder.

“Content provider” is a company eligible to possess and distribute a content. Content provider is engaged in providing its own content or rights to use the content to mobile users autonomously or via an operator, aggregator or service provider.

“Applications provider” is a company engaged in development and delivery of hardware/software designed to provide VAS-services to mobile operators, aggregators, service providers and content providers.

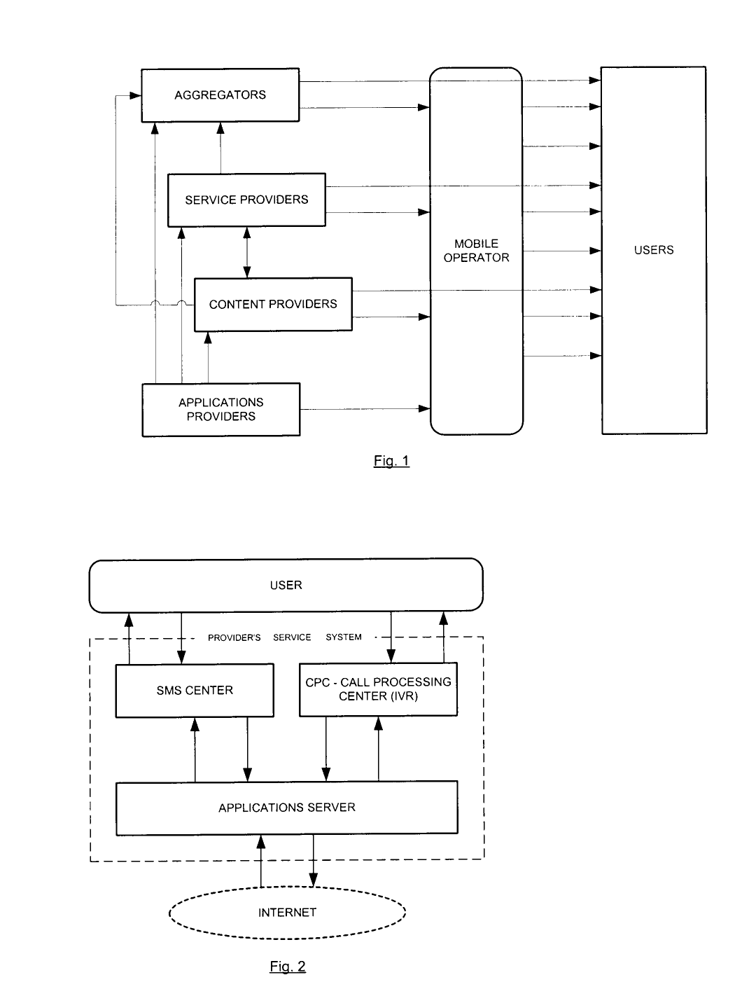

FIG. 1 shows an exemplary block diagram illustrating the interaction among all of the parties. Arrows show directions of services and/or content “movement”.

The definitions of parties and the block diagram (FIG. 1) clearly demonstrate that the same services can be provided to a user by different strings of parties which are often conditioned by technical and economical expediency in each particular case. It should be noted that in most cases a mobile operator is responsible before users for the entire string, the operation result of which is the provision of a service. In other words, the entire process of providing a service appears to a user, as a final consumer, as if it is offered by a single party, usually, a mobile operator.

The aforesaid is essential to understanding that the term “service provider” in the claim has a consolidated character and refers to any combination of parties, which have the opportunity to provide, through mutual means and operations, the service of transmitting an audio message to an e-mail address to a user, i.e. to implement a method according to the invention. The term “service provider” will be further used just in this meaning.

“Provider's service system”

Provider's service system (hereinafter referred to as “service system” or “system”) refers to a system which enables a user to access VAS-services from his mobile terminal, generally in automatic mode. The system is sometimes termed as intellectual service system, automatic service system, etc. To implement a method in accordance with the invention, a service system should include the following components: SMS-center, Call Center (hereinafter referred to as Call Processing Center or CPC) and an applications server(s) (hereinafter referred to as server(s)).

SMS-center provides automatic reception, processing of SMS requests from a user and transmission of MMS/SMS messages with the request results to the user.

CPC is a telephone/computer system which automatically receives and processes incoming calls from users and then submits data for further processing. Interactive Voice Response (IVR) systems that offer great capabilities for interactive communication between a user and a system through a voice menu tree are now widely used. By moving on the menu the user is able to receive various information and request certain services by pressing keys on his mobile terminal keypad.

Server is a hardware/software system (computer and software) that communicates, via respective interfaces, with a user, SMS-center, CPC and the Internet. Server processes information received from different components of the service system, controls subscriber databases of recorded voice messages and e-mail addresses, receives/transmits e-mail, provides the user's with access to its resources via a web-interface, etc. Depending on the volume of information being handled, there can be several servers, each configured for a definite class of tasks performed.

“Mobile terminal”

Mobile terminal is a user's portable terminal device with access to a cellular network. This term will hereinafter refer to a common mobile telephone or smart phone having various hardware/software functions that enable the user to use mobile voice communications, various VAS-services and another built-in functions (camera, dictating device, MP3 player, FM-receiver, TV-tuner, etc.).

Note that to be able to implement a method in accordance with the invention, a user can have a mobile telephone with a minimum set of functions, particularly, with the capabilities of voice communications and reception/transmission of SMS messages.

“Audio message”

Audio message refers to any audio message, including voice message, which can be transmitted by a user from his mobile telephone to CPC of the provider's service system.

CPC receives, copies and stores at the server the recorded message in an audio file (e.g. in format: MPEG, WAV, AU, WMA, OGG, etc.). It is apparent that a user can transmit a message not only by voice, but also in a form of any other audio information (background noise, music, etc.) sensed by the mobile telephone microphone. Such audio information stored as a file of definite format at the provider's server will be further referred to as “audio message” (AM).

### DESCRIPTION OF ILLUSTRATIVE EMBODIMENT

For illustration purposes, FIG. 2 shows a block diagram of components of a provider's service system, and how they interact with each other and with a user. Arrows show directions for transmitting information over various communication channels.

A user is able to remotely manage a personal database (DB) of E-Mail (EM) addresses at the provider's server.

When communicating with CPC of the provider's service system, in addition to transmission of AM the user must transmit EM address of AM recipient quickly and accurately. The simplest and most reliable method is to transmit only a number (numerals pressed on the telephone keypad) of EM address, while the string of symbols forming the EM address is stored at the server and created by the user at the server beforehand, not via the CPC, but using the provider's SMS-center or web-site, as will be discussed below.

In other words, to enable the user to indicate EM address of the AM recipient from the mobile telephone to the provider's service system CPC, the server should comprise a database of such addresses and the user should be able to manage the database remotely at any time. This ability can be practiced with the aid of SMS messages or via the provider's web site.

Managing DB of Addresses with the Aid of SMS Messages

As already mentioned before (FIG. 2) the provider's service system includes SMS-centre (usually having a short telephone number) to exchange SMS messages with a user. Examples of such exchange enabling a user to manage DB of EM address will be presented below.

(a) Creating a User's DB

DB is created simply by adding a first entry (record) i.e. a user forwards an SMS message, e.g. in such format:

[password] [symbol] [number] [symbol] [EM address] [symbol] [*] [symbol] [comment], where

[password] is an alphanumeric sequence, e.g. no more than 4 symbols;

[number] is an integer which is a unique number of the EM address. A provider specifies the length of numbers to be stored in the DB.

[EM address] is an EM address (symbols “@”, “a-z”, “A-Z”, “0-9”, “-”, “_”, “.”) meeting IETF requirements.

[*] is the asterisk symbol.

[comment] is any sequence of symbols, e.g. not more than 10 symbols.

[symbol] is the blank symbol (spacebar).

In this case, a transmitted SMS will appear as:

1a2b 1 name@domain.zn *comment

or 1a2b 1 name@domain.zn (if there is no comment).

When performing a first transmission, a user assigns a password himself, but precisely this password must be sent later on. The user has the opportunity to change the password. Number of EM address is always assigned by the user himself.

Upon reception of the SMS message, the service system SMS-center determines the user's telephone number and forwards all parameters (phone number, password and all fields of the entry) to appropriate software application at the provider's server. A respective group of entries is generated for each user's telephone number (key field) in the DB at the server, e.g. as shown in Table 1.

TABLE 1

| User phone number | E-mail | | |
|---|---|---|---|
| (key field in DB) | number | E-mail address | Comment |
| Number-1 | 55 | John@domain1 . com | John Smith |
| | 77 | Susan@domain2 . net | Susan Jackson |
| | 99 | Sam@domain3 . org | Sam Williams |
| Number-m | 1 | mmm1@dom1 . zn1 | Aaa |
| | 2 | mmm2@dom2 . zn2 | Bbb |
| | 3 | mmm3@dom3 . zn3 | Ccc |
| | 4 | mmm4@dom4 . zn4 | |
| | 5 | mmm5@dom5 . zn5 | |
| Number-n | 12 | nnn12@main1 . zn1 | Nnnnnnn1 |
| | 21 | nnn21@main2 . zn2 | |
| | 22 | nnn22@main3 . zn3 | Nnnnnnn3 |

(b) Adding a New Entry

A new entry is added to the existing DB in the same manner as described in (a).

(c) Changing an Entry

If the number of the entry being added coincides with an existing entry number, all fields of the existing entry are replaced by the added entry fields.

(d) Deleting an Entry

[password] [symbol] [DEL] [symbol] [number]—delete the entry with the indicated number; the forwarded message will appear e.g. as

1a2b DEL 55—delete the entry with number 55.

(e) Deleting a Group of Entries

[password] [symbol] [DEL] [symbol] [number1] [symbol] [number2] [symbol] [number3]—delete entries with indicated numbers; the forwarded message will appear e.g. as

1a2b DEL 55 77 99—delete entries with numbers 55, 77, 99.

(f) Deleting a Range of Entries

[password] [symbol] [DEL] [symbol] [number1]-[numberN]—delete all entries whose numbers fall into the indicated range; the forwarded message will appear e.g. as

1a2b DEL 1-77—delete all entries whose numbers are within the range from 1 to 77 inclusive.

(g) Deleting all Entries (Clear DB)

[password] [symbol] [DEL] [symbol] [ALL]—delete all entries from the DB, the password is not changed, i.e. remains as before, and the forwarded message appears e.g. as

1a2b DEL ALL

(h) Changing Existing Entry Number

[password] [symbol] [CHANGE NUM] [symbol] [number1] [symbol] [number2]—change the existing entry number, all the fields remaining as before, e.g. as

1a2b CHANGE NUM 1 2—replace number 1 of the entry by number 2; if the new number is already available in the DB, the replacement will not be done, and the system will forward an error message to the user.

(i) Receiving Information About One Entry from DB

[password] [symbol] [GET] [symbol] [number]—receive information about the entry with the indicated number; the forwarded message will appear e.g. as

1a2b GET 99

Then the user receives at his telephone an SMS message in of a sequence of fields of the entry with the number from the DB, e.g.

99 m@domain3.org Sam Williams

(j) Receiving Information About a Group of Entries from DB

[password] [symbol] [GET] [symbol] [number1] [symbol] [number2] [symbol] [number3] . . . —receive information about the entries with indicated numbers; the forwarded message will appear e.g. as

1a2b GET 55 77 99

Then the user receives an SMS message e.g.
55 John@domain1.com John Smith
77 Susan@domain2.net Susan Jackson
99 Sam@domain3.org Sam Williams

(k) Receiving Information About the Range of Entries from DB

[password] [symbol] [GET] [symbol] [number1]-[numberN]—receive information about entries whose numbers are within the indicated range inclusive; the forwarded message will appear e.g. as

1a2b GET 1-77

Then the user receives an SMS message, e.g.
55 John@domain1.com John Smith
77 Susan@domain2.net Susan Jackson

(l) Receiving Information About All Entries from DB

[password] [symbol] [GET] [symbol] [ALL]—receive information about all entries from DB; the forwarded message will appear e.g. as

1a2b GET ALL

The user receives one or more SMS messages with information about all entries. Several SMS messages are forwarded to the user if the volume of information being forwarded requires so.

(m) Changing Password

[old password] [symbol] [CHANGE PSW] [symbol] [new password]—change old password to a new one; the forwarded message will appear e.g. as

1a2b CHANGE PSW 3c4d

Then the user receives an SMS message, e.g.

NEW PSW: 3c4d

In view of the fact that the number of symbols in a single SMS message is restricted, the SMS-center may return, on the user's request, not all fields from his DB, but only the requested ones. By way of example, a user may be returned only the entry number and e-mail address, or the entry number and comment, etc. To this end, the provider may provide additional respective commands to the user.

For the sake of convenience, the user may store information from DB in a memory (e.g. address book) of his telephone.

In addition, the provider may, at discretion, do not require that the user forwarded the password to take actions on the entries in DB.

Error Correction

If the user makes some errors when operating with his DB, SMS-center of the service system can forward SMS messages to the user; by way of example, if a user tries to operate on an entry with a non-existing number, the system forwards e.g. an SMS message: “Entry with number N is not available in DB”, or e.g. the server may “check” whether the EM address transmitted by the user is valid and operable (i.e. check whether the transmitted address comprises a domain and Mail exchanger) and, based on the results, forward an SMS message about the error, if any, to the user, etc.

There is no need to list all possible errors made by a user, as the provider will be apparently able to define a list of required SMS messages about errors depending on the set of instructions provided to the user for operation with DB.

Managing DB of EM Addresses Through the Provider's Web-Site

A provider may give the user the opportunity to access his DB of EM addresses via the Internet. The user may have an authorized access to the existing DB from his computer connected to the Internet or perform registration at the web-site in order to get access to or generate his own DB.

To perform registration at the provider's web-site, the user must forward a registration request from his telephone to the service system SMS-center; the system will return a message with indicated web-site access password. The web-site access password may differ from the password used by the user to manage DB through SMS messages.

At the web-site, the provider may present a standard set functions to the user to operate on EM address table (DB), in particular, to add, delete, edit entries, and change any password.

With the authorized access to the provider's web-site, the user is able to forward autonomously the required information from the DB to his mobile telephone in the form of SMS message.

Interaction of a User with CPC

When establishing connection with CPC, a user will be presented with a voice menu enabling him to perform, by moving on the menu, the following operations:

0 Listen to options of the main menu

1 Record AM

2 Forward AM

3 Listen to AM

4 Delete AM

An exemplary voice menu will be demonstrated below, where voice messages of the automatic CPC system are presented in italics. “First message” refers to a message having an earlier entry date/time, while “last message” means a message with a later entry date/time.

Key “0”—Main Menu

When connection with CPC has been established, the user hears a voice message: “Welcome to the system for transmitting audio messages to any e-mail address. You are in the Main Menu now. Press 1 to record a new message, press 2 to send e-mail message, press 3 to hear messages, press 4 to delete messages”.

Key “1”—“Recording AM” Operation

Before the user performs this operation, the voice message: “Start recording after a short audio signal, press the pound key (#) at the end of recording. Press 0 to return to Main Menu” will be played.

After the user has ended the operation, the voice message: “Your message has been recorded. Press 2 to send the message, press 3 to hear, press 4 to delete, press 0 to return to Main Menu” is played.

Key “2”—“Forwarding AM to EM Address” Operation

Before the user performs this operation, the voice message: “Enter the address number and press the pound key at the end to send the last recorded or listened message over e-mail. Enter the numbers separated with asterisks (*), and add the pound symbol at the end to send the message to several recipients. Enter numbers of the recipients. Press 0 to return to Main Menu” will be played.

After the user has ended the operation, the voice message: “You message(s) has(ve) been sent. Press 0 to return to Main Menu” is played.

If no recorded messages are available, and the user tries to perform this operation, the voice message: “You have no recorded messages. Press 1 to record a new message” will be played.

Key “3”—“Listening to AM” Operation

Before the operation, the voice message: “You have N messages recorded. Press 1 to listen to the first message, press 2 to listen to the last message, press 3 to listen to the next message, press 4 to listen to the previous message. Press 0 to return to Main Menu. After returning to main menu, the last listened message will be used for sending or deleting” will be played.

After this operation no voice message will be played.

If the user has no recorded messages, and he tries to perform this operation, the voice message: “You have no recorded messages. Press 1 to record a new message” will be played.

Key “4”—“Deleting AM” Operation

Before the operation, the voice message: “The last recorded or listened message will be deleted now. Press the pound key to approve. Press the asterisk and pound keys to delete all messages. Press 0 to return to Main Menu” will be played.

After the operation, the voice message: “Your message(s) has(ve) been deleted. Press 0 to return to Main Menu” will be played.

If the user has no recorded messages and tries to perform this operation, the voice message: “You have no recorded messages. Press 1 to record a new message” will be played.

Operation of the service system as a whole when a user performs certain operations being in the voice menu will be explained below.

After the user has established connection with CPC, the system determines the user's telephone number, hence “knows” with AM files and EM addresses of which user the system should operate. When AM has been recorded, the system stores AM file under a specific name at the server; at the “delete” command the file will be deleted. The system positions on and plays back the AM file to enable the user to listen to it. The system knows all of the parameters needed to send the AM file via e-mail and transmits them to a respective software application at the sever, in particular, the file name and EM address (or addresses if there are several of them) according to the number entered by the user from DB of EM addresses.

It will be appreciated that a provider can change the voice menu described above and create a voice menu according to the service offered. The voice menu system should properly correct possible errors made by the user while entering information. By way of example, if a user enters a non-existing EM address number, the system must inform the user of this fact and ask him to re-enter the number.

A provider can restrict the AM length, the number of simultaneously stored AMs at the server, and the storage time. On the expiry of a certain time, AMs may be automatically deleted from the server. The user may be given the opportunity to manage AM files (delete, add new files from the user's personal computer to the provider's server, copy files from the server to the user's computer, etc.) through the provider's web-site. A provider can even do not store AMs at the server and organize the system operation so that AM is sent via e-mail immediately after it has been recorded.

A provider may require a user to enter a password (digital ID) to access the service when calling to CPC.

When sending an AM file via e-mail, the system may indicate, in the letter body, time, user's mobile telephone number, user's name and other information needed for the recipient to identify the sender.

A provider may give the user the opportunity to dial to CPC not only from a mobile telephone, but also from a wireline telephone over wireline communication channels. In this case the system must require that the user enter the personal ID to access his AM files and DB of EM addresses.

1. A method for transmitting an audio message from a mobile terminal, including a terminal without Internet access, to any electronic mail address, wherein a mobile communication user calls from the mobile terminal to a service system of a provider of the service and establishes connection with the service system; the service system identifies the user transmitting the audio message; the service system receives the user's audio message, stores the audio message as a file and transmits the file or a previously stored file to one or more electronic mail addresses indicated by the user.
